(19) United States
(12) Patent Application Publication
(10) Pub. No.: US 2013/0290372 A1
(43) Pub. Date: Oct. 31, 2013

(54) SYSTEMS AND METHODS FOR ASSOCIATING TAGS WITH FILES IN A COMPUTER SYSTEM

(71) Applicants: Jonathan WALLACE, Coral Springs, FL (US); Joseph Saib, Santa Clara, CA (US)

(72) Inventors: Jonathan WALLACE, Coral Springs, FL (US); Joseph Saib, Santa Clara, CA (US)

(73) Assignee: AppSense Limited, Warrington (GB)

(21) Appl. No.: 13/591,778

(22) Filed: Aug. 22, 2012

Related U.S. Application Data
(63) Continuation-in-part of application No. 13/457,136, filed on Apr. 26, 2012.
Application No. 13/457,136 is a continuation-in-part of application No. 13/457,150, filed on Apr. 26, 2012.

(51) Int. Cl. G06F 17/30

(52) U.S. Cl. 707/770; 707/E17.014

(57) ABSTRACT

Systems and methods are provided for providing tag suggestions for a data file. One method includes receiving a request to provide tag suggestions for a data file from a client device and identifying contextual information associated with the data file. The contextual information can include an organization chart that has a plurality of entries, and is associated with a user of the client device. The method can further include determining compatibility measures where each of the compatibility measures corresponds to one of the plurality of entries, identifying, based on the compatibility measures, one or more of the plurality of entries in the organization chart as the tag suggestions, and providing, at the tag server, the tag suggestions to the client device.

### CROSS-REFERENCE TO RELATED APPLICATIONS

This application is a continuation in part of, and claims the benefit under 35 U.S.C. §120 of the earlier priority date of U.S. patent application Ser. No. 13/457,136 entitled “SYSTEMS AND METHODS FOR PROVIDING DATA-DRIVEN DOCUMENT SUGGESTIONS,” by Joseph Saib, filed on Apr. 26, 2012, and this application is also a continuation in part of, and claims the benefit under 35 U.S.C. §120 of the earlier priority date of to U.S. patent application Ser. No. 13/457,150 entitled “SYSTEMS AND METHODS FOR AUTOMATICALLY ASSOCIATING TAGS WITH FILES IN A COMPUTER SYSTEM,” by Joseph Saib, filed on Apr. 26, 2012, both of which are expressly hereby incorporated by reference herein in their entireties.

### BACKGROUND

1. Technical Field

Disclosed systems and methods relate to associating tags with data in a computer system.

2. Description of the Related Art

Files in a computer system are often retrieved using search as a method for identifying the file, particularly in large collections of files where specifically identifying the file by file storage location becomes difficult. Search has limitations as well, stemming from its use of text strings to identify files. In some cases, many files contain identical or similar strings of text. This can cause a large number of results to be returned for certain searches performed by a standard text search engine. In other cases, files may contain limited text information, which would cause the text search to miss relevant files.

Some search systems attempt to mitigate the problem of ineffective textual searches by adding additional information to the files in the form of “tags.” Tags can include short strings of text that are assigned to individual files or chunks of content such as metadata. More than one tag may be assigned to a file. The assigned tags can be chosen informally and personally by the user of the system, and do not necessarily relate to the file's location in a hierarchical storage system. Tagging was popularized by its use on the Web by websites such as Flickr and weblogs using the WordPress content management system.

Tags can be especially useful for files without much textual information. For example, textual searches would fail to search image files unless the image files are tagged with text information, such as tags. Unfortunately, providing tags to files without much textual information is challenging and time consuming. Therefore, there is a need in the art to provide alternative tagging systems for tagging files without much textual information.

Accordingly, it is desirable to provide methods and systems that overcome these and other deficiencies of the related art.

### SUMMARY

In accordance with the disclosed subject matter, systems, methods, and non-transitory computer readable media are provided for associating tags with data in a computer system.

The disclosed subject matter includes a method. The method includes receiving, at a tag server, a request to provide tag suggestions for a data file from a client device. The method further includes identifying, at the tag server, contextual information associated with the data file, where the contextual information includes an organization chart that has a plurality of entries, and is associated with a user of the client device. The method also includes determining compatibility measures at the tag server, where each of the compatibility measures corresponds to one of the plurality of entries in the organization chart, identifying, at the tag server, based on the compatibility measures, one or more of the plurality of entries in the organization chart as the tag suggestions, and providing, at the tag server, the tag suggestions to the client device.

The disclosed subject matter also includes an apparatus for suggesting a tag for a data file in a communications network. The apparatus can include one or more interfaces configured to provide communication with a client device via the communications network. The apparatus can also include a processor, in communication with the one or more interfaces, configured to run a module stored in memory that is configured to receive a request to provide tag suggestions for the data file from the client device, identify contextual information associated with the data file, where the contextual information comprises an organization chart that has a plurality of entries, and is associated with a user of the client device, and determine compatibility measures, where each of the compatibility measures corresponds to one of the plurality of entries in the organization chart. The module stored in memory can be further configured to identify, based on the compatibility measures, one or more of the plurality of entries in the organization chart as the tag suggestions, and provide the tag suggestions to the client device.

The disclosed subject matter further includes a non-transitory computer readable medium. The computer readable medium can have executable instructions operable to cause an apparatus to receive a request to provide tag suggestions for a data file from a client device, identify contextual information associated with the data file, where the contextual information comprises an organization chart that has a plurality of entries, and is associated with a user of the client device, and determine compatibility measures, where each of the compatibility measures corresponds to one of the plurality of entries in the organization chart. The executable instructions can also be operable to cause an apparatus to identify, based on the compatibility measures, one or more of the plurality of entries in the organization chart as the tag suggestions and provide the tag suggestions to the client device.

In one aspect, the method, the apparatus, or the non-transitory computer readable medium can include steps, modules, or executable instructions for selecting a fixed number of the plurality of entries with highest compatibility measures.

In another aspect, the method, the apparatus, or the non-transitory computer readable medium can include steps, modules, or executable instructions for selecting, from the plurality of entries, those entries with a compatibility measure higher than a predetermined threshold.

In one aspect, the method, the apparatus, or the non-transitory computer readable medium can include steps, modules, or executable instructions for determining, at the tag server, whether an image of a person is present in the data file.

In one aspect, the method, the apparatus, or the non-transitory computer readable medium can include steps, modules, or executable instructions for determining a profile of a person that generated the data file.

In another aspect, the method, the apparatus, or the non-transitory computer readable medium can include steps, modules, or executable instructions for determining whether the user had tagged another data file with one of the plurality of entries.

In another aspect, the method, the apparatus, or the non-transitory computer readable medium can include steps, modules, or executable instructions for receiving the organization chart from a Lightweight Directory Access Protocol (LDAP) server.

In one aspect, the method, the apparatus, or the non-transitory computer readable medium can include steps, modules, or executable instructions for determining distances between the plurality of entries and a node corresponding to the user on the organization chart.

In another aspect, the method, the apparatus, or the non-transitory computer readable medium can include steps, modules, or executable instructions for computing the compatibility measures based on the distances between the plurality of entries and the node corresponding to the user on the organization chart.

In another aspect, the method, the apparatus, or the non-transitory computer readable medium can include steps, modules, or executable instructions for determining one of a number of up, down, or lateral edges between one of the plurality of entries and the node corresponding to the user on the organization chart.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a network connectivity diagram of a networked system in accordance with some embodiments of the disclosed subject matter.

FIG. 2 shows a flow diagram illustrating the use of factual and contextual information for suggesting tags in accordance with certain embodiments of the disclosed subject matter.

FIG. 3 illustrates a tree-structured organization chart in accordance with certain embodiments of the disclosed subject matter.

FIG. 4 illustrates how a tag server can analyze an organization chart in accordance with certain embodiments of the disclosed subject matter.

FIG. 5 is a block diagram of a client device in accordance with certain embodiments of the disclosed subject matter.

FIG. 6 is a block diagram of a tag server device, in accordance with some embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are only for examples, and that it is contemplated that there are other systems and methods that are within the scope of the disclosed subject matter.

Users of present-day computer systems often use arbitrary textual keywords called tags as metadata for documents or arbitrary content objects. Tags can include short strings of text that are associated with individual files or chunks of content such as metadata. These tags help describe documents and allow others to find the documents later by browsing or searching. Tags do not need to be related to the content of the document; instead, they are chosen by the user of the system to facilitate understanding and retrieval. For this reason, often a document will have multiple tags, and several of these tags may be different synonyms for the same general concept. This reduces the need for a user to subsequently remember the exact phrasing used in the document for purposes of later retrieval.

Tags are different from intrinsic attributes of data items. In a traditional file system, data items, such as pictures, documents, email, or social media, are typically sorted and indexed using intrinsic attributes of the data items such as the date of creation, the file size, or the file name. Intrinsic attributes are different from tags for at least three reasons. First, each intrinsic attribute can only have a single value, whereas tags can include multiple values as discussed above. Second, intrinsic attributes of a data item can only be retrieved by accessing the data item, whereas a tag of a data item can be retrieved from a storage system separate from that of the data item. Therefore, retrieving the tag does not require accessing the entire data item, which improves the performance of the storage system.

Tags became popular as a result of their use on various websites. They possess many advantages. One advantage of tags is that they can be simply visualized to facilitate browsing and retrieval. For any arbitrary number of documents, all tags used by those documents can be listed to provide a simple visualization. Often, multiple documents share the same tag, and an additional layer of information can thus be made visible by increasing the size of the text for tags that are presented more than once in the collection of documents. The resultant visualization is called a tag cloud, and its visual appeal provides a visualization that is easy to create and that allows a user to browse a collection of documents.

The benefit of tags can be even more pronounced for data files without much textual information. For example, oftentimes, image files are not associated with much textual information. Therefore, image files are hard to organize and hard to search for using conventional organizational and search mechanisms that use textual information. Tags can resolve these issues. When an image file is associated with one or more tags, the tags can serve as the textual information associated with the image file, thereby facilitating the image organization and search.

Unfortunately, tagging data files without much textual information is challenging and time-consuming. Oftentimes, tagging data files without much textual information, e.g., image files, involves extensive manual intervention of the users, and in some cases, the task can require the user to manually type the tag. Therefore, there is a need in the art to provide alternative tagging systems for tagging files without much textual information.

The disclosed subject matter includes systems and methods for providing tags to files without much textual information in a computer system. When a user decides to tag a file, the disclosed systems and methods can provide suggested tag candidates to the user, and the user can select one of the suggested tags to tag the file. In some embodiments, the disclosed systems and methods can suggest tag candidates based on contextual information. For example, the disclosed systems and methods can suggest names of people as tag suggestions, based on how often the user meets with the people associated with those names. In some cases, the disclosed systems and methods can automatically tag a file based on the contextual information.

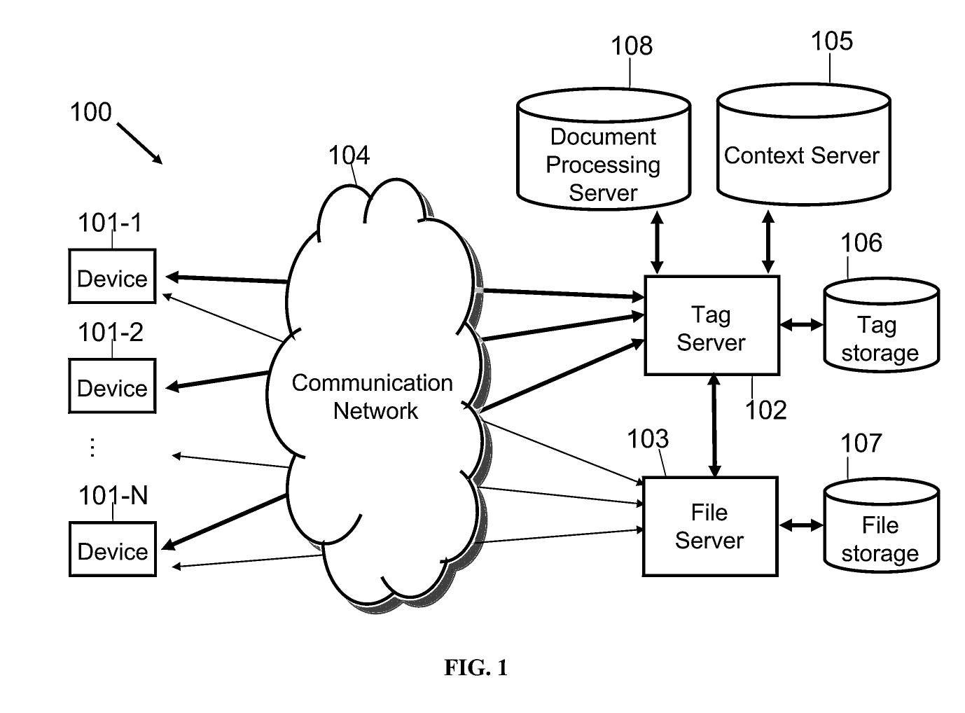

FIG. 1 is a network diagram in accordance with some embodiments of the disclosed subject matter. Network system 100 is a client/server system, in which at least one client 101 (e.g., devices 101-1, 101-2, . . . 101-n), a tag server 102, and a file server 103, communicate via a communication network 104. Tag server 102 can communicate with file server 103, a context server 105, a tag storage 106, and a document processing server 108. The device 101 can include a mobile device or user-operated device associated with a user. The device 101 can be any suitable device, including desktop computers, mobile computers, tablet computers, and cellular phones, including smartphones (e.g., Apple iPhones, RIM BlackBerry devices, or Android-based smartphones). Users can use the device 101 to perform searches for documents and files. In some embodiments, the device 101 can communicate directly with the file server 103 to retrieve the documents or files using intrinsic attributes. In other embodiments, the device 101 can also communicate with the tag server 102 to retrieve the documents or files using tags.

The file server 103 can retrieve the requested documents and files from a file storage 107, and send them to the device 101. The file server 103 may be a standard Microsoft Windows file server, web server, WebDAV server, or other file server. The file storage 107 can include a non-transitory computer readable medium. In some embodiments, the tag server 102 may provide proxy capability to intercept requests for files before the requests are sent to the file server 103. The file server 103 can directly send the files to the devices 101 in some embodiments. The tag server 102 may provide search capability, and this search capability may be provided via a webpage served by the tag server 102, via an enterprise search application such as Autonomy, or via a document management system such as iManage WorkSite, or another system, according to some embodiments.

The tag server 102 can communicate with a tag storage 106 to store or retrieve tags from the tag storage 106. The tag storage 106 can include a non-transitory computer readable medium. The non-transitory computer readable medium can include a flash memory, a magnetic disk drive, an optical drive, a programmable read-only memory (PROM), a read-only memory (ROM), a random access memory (RAM), or any other memory or combination of memories. In some embodiments, the tag storage 106 and the file storage 107 can be located in the same computer readable medium.

The tag server 102 can receive request from the client device 101 to provide tag suggestions to the device 101. In some embodiments, the tag server 102 can create tag suggestions using contextual information. The contextual information can include information about a user, a computer system, file(s), folders, and/or any objects associated with the file being tagged. For example, the contextual information can include a list of people in contact with the user, a list of people in frequent contact with the user, a list of coworkers of the user, an organization chart of the user's coworkers, a list of people authorized to access the file being tagged, a list of people authorized to access the folder in which the file being tagged is located, and/or an itinerary of a trip taken by the user within a predetermined period of time.

In some embodiments, the tag server 102 can receive the contextual information from a context server 105 that is configured to maintain and provide contextual information. The context server 105 can be within communication network 104, which may be the public Internet, may be a private intranet controlled by an organization or company, or may be another network.

In some embodiments, the tag server 102 can use the contextual information to tag a data file without much text information. The data file without much text information can include an image, which may include a photograph, a picture, a drawing, a sketch, a symbol, an advertisement, or any types of graphic representations.

In some embodiments, the tag server 102 can communicate with the document processing server 108 to process a data file. In some cases, the document processing server 108 can include a person detection system that is capable of detecting a person in a data file, such as an image. The document processing server 108 can also be equipped with a face recognition system that can detect and correlate a person's face across multiple images. The document processing server 108 can provide the extracted information to the tag server 102 so that the tag server can make informed tag suggestions.

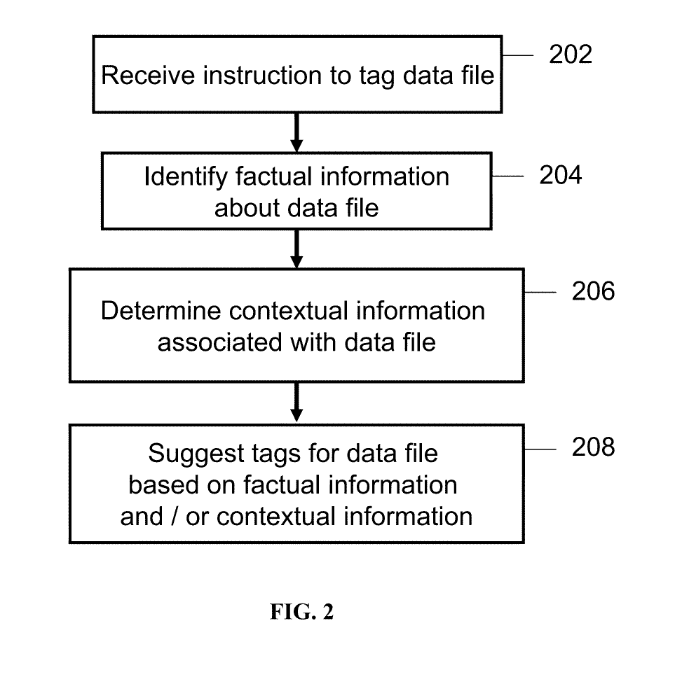

FIG. 2 illustrates a process of tagging a data file without much textual information in accordance with certain embodiments of the disclosed subject matter. While the following description of FIG. 2 illustrates that the steps of FIG. 2 can be performed at a tag server 102, the client device 101 or the file server 103 can also perform the steps of FIG. 2. In step 202, the tag server 102 can receive a tag suggestion request, requesting the tag server 102 to provide tag suggestions for a data file without much textual information. The received tag suggestion request can include an identification of the data file to be tagged. The tag suggestion can be received from a client device 101 or a file server 103.

In step 204, the tag server 102 can identify factual information about the data file. The factual information includes the information that can be derived from the data file itself. For example, the factual information can include one or more of the following: the time at which the data file was generated or captured, the location at which the data file was generated or captured, whether the data file depicts an indoor or an outdoor scene, whether the data file captures any recognizable objects such as desks, chairs, cars, streets, buildings, people, trees, rocks, river, sea, or any other objects that can provide factual information about the data file.

In some embodiments, if the data file is an image, the tag server 102 can process the data file to determine the factual information about the data file. For example, the tag server 102 can process the data file using an object/scene recognition system to identify the characteristics associated with the image. In some cases, the object/scene recognition system can include a face recognition system that can determine whether or not a person is present in the image, and if a person is present, what the name of the person is. The object/scene recognition system can include a Scale Invariant Feature Transform (SIFT) detector, a Viola-Jones face detector, an Eigenface detector for face recognition, a face recognition module based on boosting techniques, and an object recognition module based on context models.

In other embodiments, if the data file is an image, the tag server 102 can receive factual information about the data file from a stand alone, image processing system. The tag server 102 can send a factual information request to the image processing system, the request including an identification of the data file. In response to receiving the factual information request, the image processing system can process the data file to determine the factual information and to provide the determined factual information to the tag server 102.

In step 206, the tag server 102 can determine the contextual information associated with the data file. The contextual information can include information about the context in which the file is used, stored, and/or generated, and information about the person using the file, tagging the file, owning the file, or generated the file. For example, the contextual information can include the profile of the person tagging the data file (i.e., the user,) the profile of the person owning the data file, the profile of the person that generated the data file, the list of people in contact with the user, the list of people in frequent contact with the user, the list of people that the user has met during a certain period of time, or the list of places that the user has visited within a certain period of time, etc. In some embodiments, the tag server 102 can receive the contextual information from the context server 105. In other embodiments, the tag server 102 can independently determine the contextual information.

In step 208, the tag server 102 can determine tag candidates that are likely to be associated with the data file, and send a tag suggestion response, including the determined tag candidates, to the device requesting the tag suggestions.

In some embodiments, the steps illustrated in FIG. 2 can be used to provide tag suggestions for images of people. With the advent of photo-sharing sites, such as Facebook, and the photo-sharing feature of corporate computer systems, people share a large number of images online, publicly or internally. Oftentimes, people choose to provide additional information about the shared images, in particular, the name of the person pictured in images. Unfortunately, the mechanism for providing the name of the person in the image is cumbersome and time consuming. The steps illustrated in FIG. 2 can be used to suggest names to be associated with the images.

In step 202, the tag server 102 can receive a tag suggestion request to provide tag suggestions for an image. The tag suggestion request can be received from a user of a client device 101. In step 204, the tag server 102 can determine the factual information associated with the image. In this step, the tag server 102 can identify that the image includes one or more person(s). In some embodiments, the tag server 102 can use a person detection system to identify that the image includes one or more person(s). The person detection system can include one or more of a face detection system, a face recognition system, a clothing detection system, a hair detection system, an eye detection system, a limb detection system, or any other types of systems capable of identifying that the image includes one or more person(s).

In step 206, the tag server 102 can determine the contextual information associated with the image. The contextual information to be determined for the image can depend on the factual information determined in step 204. The contextual information can include a list of candidates that may be associated with the detected person in step 204.

In some embodiments, the list of candidates can be determined from a contact database. Because the contact database can include the people in contact with the user, the contact database can provide a list of probable candidates that can be associated with the detected person in step 204. The contact database can include a personal, private database, including an address book or a contact list associated with the user. The contact database can include a public database, such as Yellow Pages. The contact database can also include an internal database of an organization, accessible by members of the organization. The internal database of an organization can provide a list of people in the same organization as the user.

In some embodiments, the internal database of an organization can be organized in a hierarchy. Such an internal database having an hierarchy is also known as an organization chart. The organization chart is different from an address book or a contact list because while the address book or the contact list is a private, personal list that can only be accessed by the user, the organization chart is an internal information that can be shared by the people in the same organization.

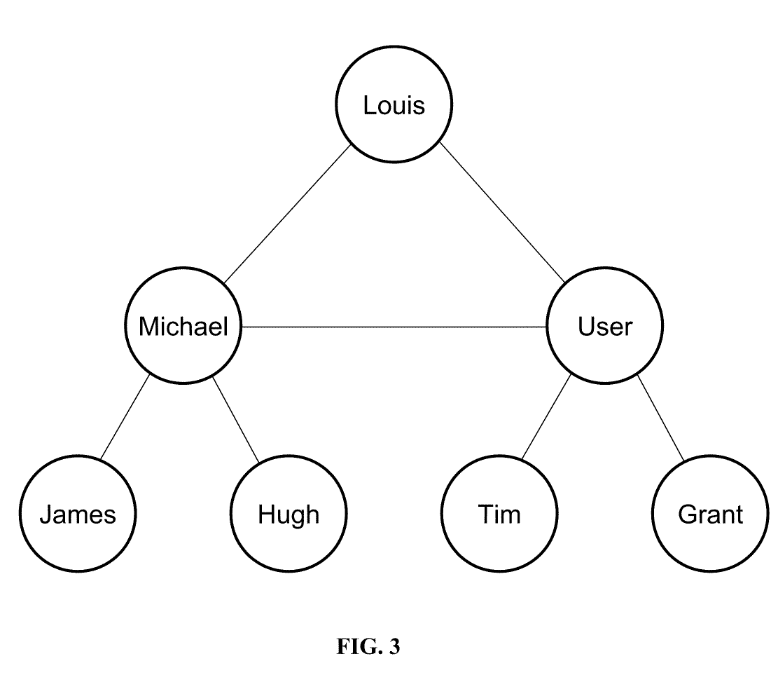

In some cases, the organization chart can have a tree structure, illustrating the rank of people in the organization. FIG. 3 illustrates a tree-structured organization chart in accordance with certain embodiments of the disclosed subject matter. This organization chart shows that the organization includes the user, Louis, Michael, James, Hugh, Tim, and Grant. The organization chart also shows that the user's superior is Louis, that the user's colleague is Michael, and that the user's subordinates include Tim and Grant.

In some embodiments, the organization chart can be maintained in a Light Weight Directory Access Protocol (LDAP) server. The LDAP server can be a part of the contextual server 105 or can be a stand alone server accessible over the network. When the tag server 102 requests the LDAP server to provide the organization chart associated with the user, the LDAP server can prepare a data structure including the organization chart, and provide the data structure to the tag server 102.

In step 208, the tag server 102 can analyze the factual information and the contextual information to determine the tag suggestions for the data file. In some embodiments, the tag server 102 can analyze the organization chart to determine how likely it is that a person would have appeared in the data file.

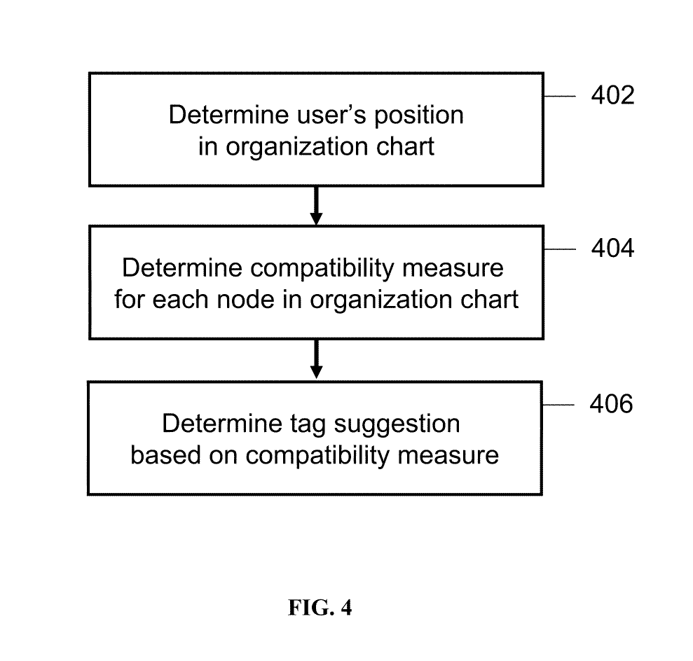

FIG. 4 illustrates how a tag server can analyze an organization chart in accordance with certain embodiments of the disclosed subject matter. In step 402, the tag server 102 can determine where the user is located in the organization chart (i.e., the node associated with the user in the organization chart). This step essentially determines the reference node from which the distance of other nodes can be computed.

In step 404, the tag server 102 can determine the compatibility measure of other nodes with respect to the user's node. In some embodiments, the tag server 102 can determine the compatibility measure of other nodes based on the distance between the reference node (i.e., the user's node) and the other nodes. The distance between a reference node and a target node can be represented as a number of moves required to reach the target node from the reference node on the organization chart. For example, based on the organization chart of FIG. 3, the distance between the user and James is one “lateral” and one “down.” As another example, the distance between Tim and Hugh is one “up”, one “lateral,” and one “down.” In some cases, the distance between two nodes can be represented as a triplet: (dᵤ,d_{d},dₗ), where dᵤ represents the number of “up” moves, d_{d} represents the number of “down” moves, and dₗ represents the number of “lateral” moves. The distance between a reference node and a target node essentially indicates the least number of up, down, and lateral edges between the reference node and the target node on the organization chart.

The tag server 102 can translate the distance (dᵤ,d_{d},dₗ) into a distance compatibility measure using a distance compatibility measure function. In some embodiments, a distance compatibility measure function can be based on sub-functions associated with each of the elements in the distance triplet. For example, the distance compatibility measure function can be represented as the sum of sub-functions as follows:

S(dᵤ,d_{d},dₗ)=fᵤ(dᵤ)+f_{d}(d_{d})+fₗ(dₗ)

where fᵤ (dᵤ) indicates the sub-function associated with the “up” moves, f_{d} (d_{d}) represents the sub-function associated with the “down” moves, and fₗ(dₗ) represents the sub-function associated with the “lateral” moves. In another example, the distance compatibility measure function can be represented as the product of sub-functions as follows:

S(dᵤ,d_{d},dₗ)=fᵤ(dᵤ)f_{d}(d_{d})fₗ(dₗ)

In other examples, the distance compatibility measure function can be any suitable combinations of sub-functions, where the suitable combinations of sub-functions can include a summation, a subtraction, a multiplication, a division, and/or an exponentiation of the sub-functions.

The sub-functions can be any type of function, preferably a monotonically decreasing function. For example, the sub-functions can be exponential functions: fᵤ(dᵤ)=Kᵤ exp(−λᵤdᵤ), f_{d}(d_{d})=K_{d} exp(−λ_{d}d_{d}), fₗ(dₗ)=Kₗ exp(−λₗdₗ). The parameters Kᵤ, λᵤ, K_{d}, λ_{d}, Kₗ and λₗ can be determined heuristically to improve the effectiveness of the distance compatibility measure function in providing the tag suggestions. In some cases, fᵤ, f_{d}, and fₗ can be identical.

In certain embodiments, the compatibility measure can also depend on other factors. The other factors can include one or more of the following: the number of times the user has interacted with a person associated with a candidate tag, whether or not the user has recently tagged other data files with a person associated with a candidate tag, and whether other people tagged other data files with the user's name and a candidate tag. The final compatibility measure can be solely based on the distance compatibility measure, or can be based on the sum of the distance compatibility measure and the compatibility measures based on the other factors illustrated above.

In step 406, the tag server 102 can use the final compatibility measures to determine the tag suggestions. In some embodiments, the tag server 102 can determine the tag suggestions by selecting candidates with high compatibility measures. For example, the tag server 102 can select candidates with the 10 highest compatibility measures as the tag suggestions. In other embodiments, the tag server 102 can determine the tag suggestions by selecting candidates with compatibility measures that are greater than a predetermined threshold. The tag server 102 can use any suitable number of compatibility measures, any other suitable metrics, or any combinations thereof.

The tag server 102 can provide the determined tag suggestions to the client device 101. Subsequently, the client device 101 can provide the suggested tags to the user so that the user can select one of the suggested tags as the tag for the data file. When the user selects a tag for the data file, the tag can appear next to the data file. When a user hovers over the tag, the client device 101 can provide a context menu to the user, asking if the user wants to send the tagged data file to the person associated with the tag, for instance, via email.

In some embodiments, a tag server 102 can automatically tag a data file instead of simply suggesting candidate tags. For example, the tag server 102 can compute compatibility measures for candidate tags, and subsequently select the candidate with the highest compatibility measure as the tag for the data file.

In some embodiments, the steps illustrated in FIG. 2 can be performed entirely at a client device 101. For example, the client device 101 can receive an instruction from the user to provide tag suggestions for a data file. The client device 101 can subsequently determine the factual information and the contextual information associated with the data file, determine the tag suggestions for the data file, and provide the determine tag suggestions to the user.

In some embodiments, the steps illustrated in FIG. 2 can be performed entirely at a file server 103. For example, the file server 103 can determine the factual information and the contextual information associated with the data file, determine the tag suggestions for the data file, and maintain the determined tag suggestions for future use. In some cases, the file server 103 can perform the steps of FIG. 2 as a background process for tagging all data files in the file server 103.

In some embodiments, the tag server 102 can track the tags selected by the user and use that information to provide better tag suggestions for other data files. For example, if the user selects James as a tag for a data file in a folder, the tag server 102 can increase the likelihood of suggesting James as a tag for other data files in the same folder.

In some embodiments, the tag server 102 can improve the tag suggestions for a data file based on the similarity between the tagged data files and the data file to be tagged. For example, when a user tags an image as “James,” the tag server 102 can use a person recognition system to identify all images including the same person as the image tagged “James.” Subsequently, when a user requests tag suggestions for images having the same person as the image tagged “James,” the tag server 102 can increase the likelihood of suggesting “James” as a tag for the new image. The accuracy of such tag propagation can improve as the number of images tagged “James” increases. For example, the tag server 102 can retrieve images having a particular tag, determine the common person in those images, and associate the particular tag with the common person. This mechanism can work even if tags are applied to images without specifying which tag is associated with which person in the tagged image.

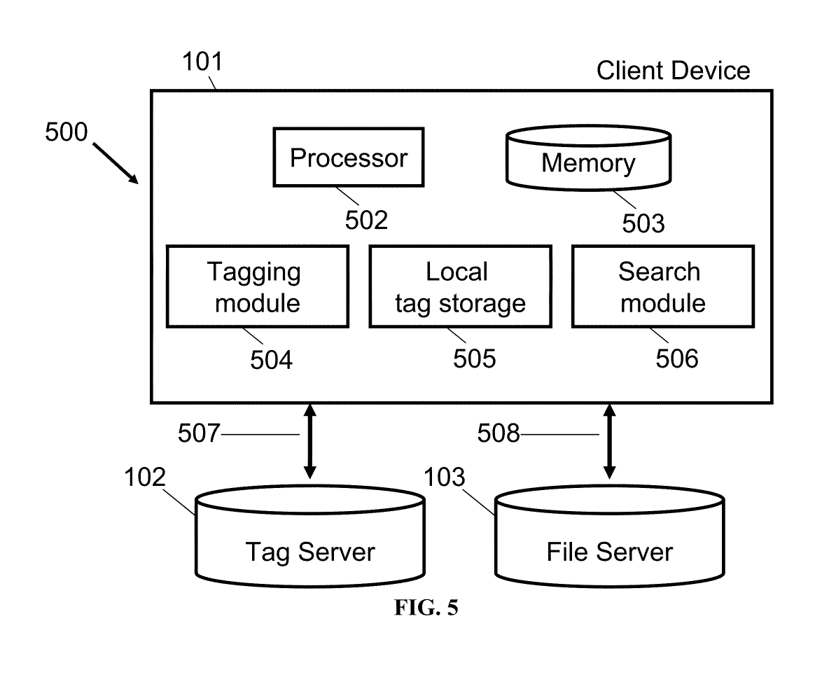

FIG. 5 is a block diagram of a client device in accordance with certain embodiments of the disclosed subject matter. The block diagram 500 shows a client device 101, which includes processor 502, memory 503, a tagging module 504, a local tag storage 505, and a search module 506. The client device 101 can be coupled to a tag server 102 via the interface 507 and the file server 103 via the interface 508. The interfaces 507 and 508 are shown as separate physical interfaces but may be the same physical interface.

In some embodiments of the disclosed subject matter, the client device 101 can include additional modules, fewer modules, or any other suitable combination of modules that perform any suitable operation or combination of operations. The memory 503 can be a non-transitory computer readable medium, flash memory, a magnetic disk drive, an optical drive, a programmable read-only memory (PROM), a read-only memory (ROM), or any other memory or combination of memories. The software runs on a processor 502 capable of executing computer instructions or computer code. The processor 502 might also be implemented in hardware using an application specific integrated circuit (ASIC), programmable logic array (PLA), field programmable gate array (FPGA), or any other integrated circuit.

At least interfaces 507 and 508 provide an input and/or output mechanism to communicate over a network. The interfaces 507 and 508 enable communication with servers, as well as other network nodes in the communication network. The interfaces 507 and 508 are implemented in hardware to send and receive signals in a variety of mediums, such as optical, copper, and wireless, and in a number of different protocols some of which may be non-transient. The interfaces 507 and 508 may be the same interface.

The client device 101 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, Apple iOS, RIM BlackBerry OS, Windows Mobile, Linux, HP WebOS, and Android. The screen may be a touch screen that is used to input data to the mobile device, in which case the screen can be used instead of the full keyboard. The user equipment can also keep global positioning coordinates, profile information, or other location information.

The client device 101 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client device 101 is configured with one or more processors 502 that process instructions and run software that may be stored in memory. The processor 502 also communicates with the memory and interfaces to communicate with other devices. The processor 502 can be any applicable processor such as a system-on-a-chip that combines a CPU, an application processor, and flash memory. The client device 101 can also provide a variety of user interfaces such as a keyboard, a touch screen, a trackball, a touch pad, and/or a mouse. The client device 101 may also include speakers and a display device in some embodiments.

When searching for one or more documents using search terms, or when assigning tags, the tagging module 504 may perform several functions. These functions can include: sending a tag suggestion request to a tag server to receive tag suggestions for a file, analyzing files and their contents to identify tag suggestions for a file in response to a request by a user, correlating one set of tags with another set of tags to improve retrievability and consistency, receiving factual information and contextual information about the file from a document processing server 108 and/or a context server 105, automatically assigning a tag to a document based on the tag suggestions, and other functions.

When tags are assigned, the tags can be stored in the local tag storage 505. Storing may occur in the form of an association between a file and a tag. They may also occur in the form of associations from between a file and a plurality of tags. Other associations may also be contemplated, in some embodiments. The local tag storage 505 may be synchronized with the tag server 102, periodically or on an as-needed basis or at other times. The search module 506 provides a user interface for searching for one or more files, and interfaces with the tagging module 504. The search module 506 or the tagging module 504 communicates with the file server 103 to retrieve requested documents.

Although the processor 502 performs one or more steps described in the flow diagram of FIGS. 2 and 4, multiple sub-modules may exist within either the software or hardware of the client device 101 that provide supporting functionality.

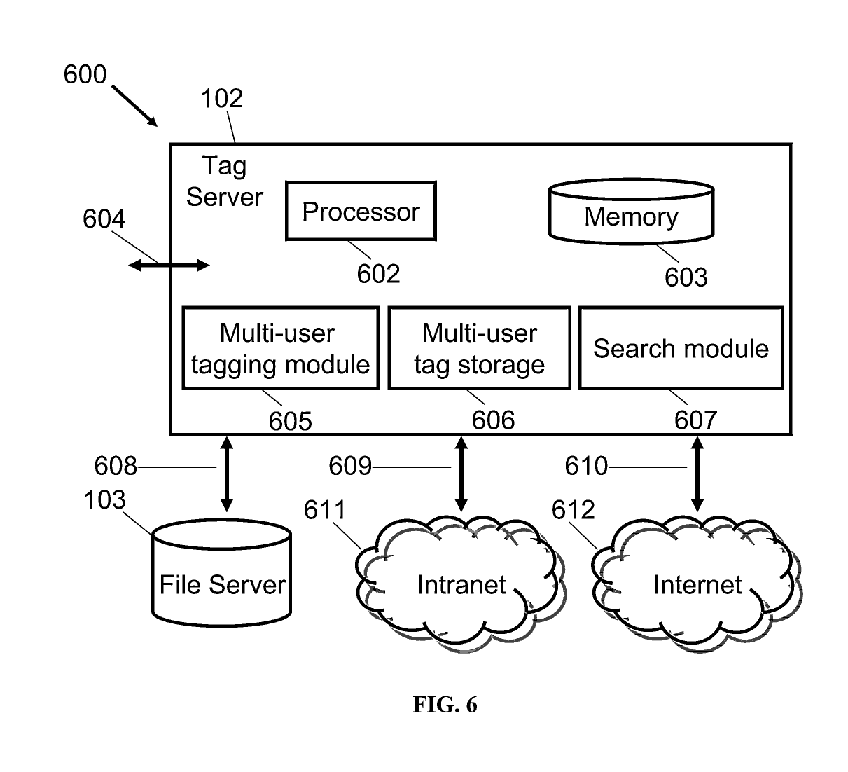

FIG. 6 is a block diagram of a tag server device, in accordance with some embodiments of the disclosed subject matter. The tag server device 102 includes a processor 602, memory 603, a multi-user tagging module 605, a multi-user tag storage 606, and a search module 607. The tag server 102 can communicate with client device 101 (not shown) via interface 604. The tag server 102 may communicate with the file server 103 via interface 608. The tag server 102 may communicate with intranet 611 via interface 609. The tag server 102 may communicate with Internet 612 via interface 610. The tag server can communicate with intranet 611 or Internet 612 to reach client devices 101 or other servers, such as a file server 103, another tag server, a context server 105, or a document processing server 108.

As described for block diagram 600, a multi-user tagging module 605, a multi-user tag storage 606, and a search module 607 are provided. The operation of these modules is similar to the operation of the analogous modules in block diagram 500, but their functions are performed across multiple users and on any and all files available to the tag server 102, which may be a superset of the files available to each local device. The multi-user tagging module 605 thus corresponds to the tagging module 504 and provides tagging modules for one or more users and uses tags that are used by all users; the multi-user tag storage 606 corresponds to the local tag storage 505 and stores tags used by all users; and the search module 607 corresponds to the search module 506 and provides search for documents stored on behalf of all users or that are made accessible on the network. Additionally, tags may be requested from the multi-user tag service 605 by the client devices 101, in order to provide consistent tags throughout an organization consisting of many client devices that provide and include tagging modules. Additionally, more resources for identifying tags, particularly based on lexical analysis, may be available on intranet 611 and Internet 612.

The processor 602 performs processing for one or more modules as disclosed in this specification. The memory 603 provides temporary storage of data as required by the processor 602. The memory 603 can be a non-transitory computer readable medium, flash memory, a magnetic disk drive, an optical drive, a programmable read-only memory (PROM), a read-only memory (ROM), or any other memory or combination of memories. The software runs on a processor 602 capable of executing computer instructions or computer code. The processor 602 may also be implemented in hardware using an application specific integrated circuit (ASIC), programmable logic array (PLA), field programmable gate array (FPGA), or any other integrated circuit.

Although the processor 602 performs one or more steps described in the flow diagram of FIGS. 2 and 4, multiple sub-modules may exist within either the software or hardware of tag server 102 that provide supporting functionality.

The tag server 102 can operate using an operating system (OS) software. In some embodiments, the OS software is based on a Linux software kernel and runs specific applications in the tag server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The tag server's software can be divided into a series of tasks that perform specific functions. These tasks communicate with each other as needed to share control and data information throughout the tag server 102. A task can be a software process that performs a specific function related to system control or session processing. Three types of tasks operate within the tag server 102 in some embodiments: critical tasks, controller tasks, and manager tasks. The critical tasks control functions that relate to the tag server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the tag server 102 include a system initiation task subsystem, a high availability task subsystem, a shared configuration task subsystem, and a resource management subsystem.

The system initiation task subsystem is responsible for starting a set of initial tasks at system startup and providing individual tasks as needed. A high availability task subsystem works in conjunction with the recovery control task subsystem to maintain the operational state of the tag server 102 by monitoring the various software and hardware components of the tag server 102. A recovery control task subsystem is responsible for executing a recovery action for failures that occur in the tag server 102 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the tag server 102 with an ability to set, retrieve, and receive notification of server configuration parameter changes and is responsible for storing configuration data for the applications running within the tag server 102. A resource management subsystem is responsible for assigning resources (e.g., processor and memory capabilities) to tasks and for monitoring the task's use of the resources.

In some embodiments, the tag server 102 can reside in a data center and form a node in a cloud computing infrastructure. The tag server 102 can also provide services on demand. A module hosting a client is capable of migrating from one server to another server seamlessly, without causing program faults or system breakdown. The tag server 102 in the cloud can be managed using a management system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. For example, while this disclosure discusses search in detail, other methods for retrieving documents may also provide embodiments that are in accordance with the disclosed subject matter, such as retrieval via browsing, retrieval using a hierarchical file structure, retrieval using a tag cloud, etc. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving, at a tag server, a request to provide tag suggestions for a data file from a client device;
identifying, at the tag server, contextual information associated with the data file, wherein the contextual information comprises an organization chart that has a plurality of entries, and is associated with a user of the client device;
determining compatibility measures at the tag server, wherein each of the compatibility measures corresponds to one of the plurality of entries in the organization chart;
identifying, at the tag server, based on the compatibility measures, one or more of the plurality of entries in the organization chart as the tag suggestions; and
providing, at the tag server, the tag suggestions to the client device.

2. The method of claim 1, wherein identifying, based on the compatibility measures, one or more of the plurality of entries as the tag suggestions comprises selecting a fixed number of the plurality of entries with highest compatibility measures.

3. The method of claim 1, wherein identifying, based on the compatibility measures, one or more of the plurality of entries as the tag suggestions comprises selecting, from the plurality of entries, those entries with a compatibility measure higher than a predetermined threshold.

4. The method of claim 1, further comprising determining, at the tag server, whether an image of a person is present in the data file.

5. The method of claim 1, wherein identifying the contextual information associated with the data file comprises determining a profile of a person that generated the data file.

6. The method of claim 1, wherein identifying the contextual information associated with the data file comprises determining whether the user had tagged another data file with one of the plurality of entries.

7. The method of claim 1, wherein identifying the contextual information associated with the data file comprises receiving the organization chart from a Lightweight Directory Access Protocol (LDAP) server.

8. The method of claim 1, wherein determining the compatibility measures comprises determining distances between the plurality of entries and a node corresponding to the user on the organization chart.

9. The method of claim 8, wherein determining the compatibility measures comprises computing the compatibility measures based on the distances between the plurality of entries and the node corresponding to the user on the organization chart.

10. The method of claim 8, wherein determining the distances between the plurality of entries and the node corresponding to the user on the organization chart comprises determining one of a number of up, down, or lateral edges between one of the plurality of entries and the node corresponding to the user on the organization chart.

11. An apparatus for suggesting a tag for a data file in a communications network, the apparatus comprising:
one or more interfaces configured to provide communication with a client device via the communications network; and
a processor, in communication with the one or more interfaces, configured to run a module stored in memory that is configured to:
receive a request to provide tag suggestions for the data file from the client device;
identify contextual information associated with the data file, wherein the contextual information comprises an organization chart that has a plurality of entries, and is associated with a user of the client device;
determine compatibility measures, wherein each of the compatibility measures corresponds to one of the plurality of entries in the organization chart;
identify, based on the compatibility measures, one or more of the plurality of entries in the organization chart as the tag suggestions; and
provide the tag suggestions to the client device.

12. The apparatus of claim 11, wherein the module is further configured to identify whether a face of a person is present in the data file.

13. The apparatus of claim 11, wherein the module is further configured to determine distances between the plurality of entries and a node corresponding to the user on the organization chart.

14. The apparatus of claim 13, wherein the module is further configured to compute the compatibility measures based on the distances between the plurality of entries and the node corresponding to the user on the organization chart.

15. The apparatus of claim 11, wherein the module is further configured to determine whether the user had tagged another data file with one of the plurality of entries.

16. The apparatus of claim 11, wherein the module is further configured to receive the organization chart from a Lightweight Directory Access Protocol (LDAP) server.

17. A non-transitory computer readable medium having executable instructions operable to cause an apparatus to:
receive a request to provide tag suggestions for a data file from a client device;
identify contextual information associated with the data file, wherein the contextual information comprises an organization chart that has a plurality of entries, and is associated with a user of the client device;
determine compatibility measures, wherein each of the compatibility measures corresponds to one of the plurality of entries in the organization chart;
identify, based on the compatibility measures, one or more of the plurality of entries in the organization chart as the tag suggestions; and
provide the tag suggestions to the client device.

18. The computer readable medium of claim 17, wherein the computer readable medium further includes executable instructions operable to cause the apparatus to determine distances between the plurality of entries and a node corresponding to the user on the organization chart.

19. The computer readable medium of claim 18, wherein the computer readable medium further includes executable instructions operable to cause the apparatus to compute the compatibility measures based on the distances between the plurality of entries and the node corresponding to the user on the organization chart.

20. The computer readable medium of claim 17, wherein the computer readable medium further includes executable instructions operable to cause the apparatus to receive the organization chart from a Lightweight Directory Access Protocol (LDAP) server.
